(19) United States
(12) Patent Application Publication
(10) Pub. No.: US 2009/0310732 A1
(43) Pub. Date: Dec. 17, 2009

(54) Method for manufacturing a pressure vessel of a pressurized-water reactor of a nuclear power station a pressure vessel of a pressurized-water reactor of a nuclear power station and use of a multiwalled pressure vessel for the above purpose

(76) Inventor: Sulo Luomala, Espoo (FI)

Correspondence Address: EMERGING STRATEGIES, LLP, 7416 LYNNHURST STREET, CHEVY CHASE, MD, 20815-3102, US

(21) Appl. No.: 11/518,847

(22) Filed: Sep. 11, 2006

Related U.S. Application Data
(63) Continuation of application No. PCT/FI04/00811, filed on Dec. 31, 2004.

(30) Foreign Application Priority Data
Mar. 11, 2004 (FI) FI20040387

(51) Int. Cl. G21C 9/00

(52) U.S. Cl. 376/294

(57) ABSTRACT

The invention relates first of all to a method for manufacturing a pressure vessel of a pressurized-water reactor of a nuclear power station, which pressure vessel comprises a pressure resistant casing and which is being used filled with a medium in high pressure in order to utilize heat, being generated as a result of a nuclear reaction taking place in an internal space (13) of the pressure vessel, by means of a heat exchange arrangement or like, being in connection with the pressure vessel. A casing of a pressure vessel (1) of a pressurized water reactor, is being manufactured from two or more shell structures (5, 6) existing one within the other, whereby an essentially lower pressure than the pressure existing in an internal space (13) of the pressure vessel is being arranged in an intermediate space (12) between the shell structures. The invention relates also to a pressure vessel of a pressurized-water reactor of a nuclear power station and to use of a multiwalled pressure vessel for the above purpose.

Method of manufacturing a pressure vessel of a pressurized-water reactor of a nuclear power station, a pressure vessel of a pressurized-water reactor of a nuclear power station and use of a multiwalled pressure vessel for the above purpose

The invention relates to a method for manufacturing a pressure vessel of a pressurized-water reactor of a nuclear power station, which pressure vessel comprises a pressure resistant casing and, which is being used filled with a medium in high pressure in order to utilize heat, being generated as a result of nuclear reaction taking place in an internal space of the pressure vessel, by means of a heat exchange arrangement or like, being in connection with the pressure vessel.

A pressure vessel of a pressurized-water reactor of a nuclear power station must be dimensioned for well understandable reasons so that its safety is guaranteed under all circumstances. This is why a pressure vessel, being manufactured traditionally from metal by casting, is first of all due to its external dimensions and big wall thickness extremely labourious and demanding to manufacture. This kind of a pressure vessel is being casted nowadays usually in two pieces from massive metal, in which connection the cast itself is a very demanding and long lasting measure as such. On the other hand also transportation of the casted and mounted pressure vessel to its operating site and placement of the same in position require very big/efficient transportation and lifting devices. Furthermore different kinds of machining measures to be carried out for the pressure vessel, such as making of through holes, are very demanding to make on site particularly due to the big wall thickness of the pressure vessel. Furthermore the traditionally manufactured pressure vessels nowadays even limit the efficiency of a nuclear power station; the present reactor pressure vessels weight in maximum approximately 800 tons, which makes possible to achieve an efficiency of approximately 1.6 megaW.

It is an aim of the present method according to the invention to achieve a decisive improvement in the problems described above and thus to raise essentially the level of prior art technique in the field. In, order to carry out this aim, the method according to the invention is primarily characterized in that a casing of a pressure vessel of a pressurized-water reactor is being manufactured from two or more shell structures existing one within the other, whereby an essentially lower pressure than the pressure existing in an internal space of the pressure vessel, is being arranged) in an intermediate space between, the above shell structures.

As the most important advantage of the method according to the invention may be mentioned decisive facilitation of the manufacturing of a pressure vessel of a pressurized-water reactor of a nuclear power station in a way, that putting together of the same is even possible on site. Thanks to the method according to the invention there is thus not any more need for special arrangements for transporting very massive casted parts or lifting measures e.g. when they are being positioned in place. The method according to the invention enables furthermore measuring of a pressure vessel of a pressurized-water reactor optimally in a way that it as such does not limit the maximum efficiency to be produced by a nuclear power station, as is the case with prior art techniques. On the other hand utilization of all of the efficiency produced by a pressure vessel and the limited internal space of a pressure vessel have traditionally led to solutions, in which the high active water is being circulated in heat exchangers outside the reactor. Thanks to the invention, it is not necessary to lead the high active water outside the reactor vessel at all, but instead the heat exchange may be carried out internally within the pressure vessel by placing the heat exchanger into intermediate spaces between the casing structures. In this way a remarkable improvement in safety is achieved.

The invention relates also to a pressure vessel of a pressurized-water reactor of a nuclear power station, which has been defined in detail in the preamble of the independent claim related to the same. The characterizing features of the pressure vessel of a pressurized-water reactor have been presented in the characterizing part of the corresponding claim.

As the most important advantage of a pressure vessel of a pressurized-water reactor may be mentioned the easiness of its manufacturing and installation when compared to present solutions. This is particularly thanks to the fact that putting together of the casing of a pressure vessel of a reactor with a two or more layered casing is possible to make on site, in which connection there is not anymore a need for expensive special transportation or lift arrangements, which is the case at present, when mounting in position those heavy pressure vessels made of cast metal. Thanks to the pressure vessel of a pressurized-water reactor according to the invention, it is thus possible to decrease decisively the manufacturing costs and on the other hand even to make the use of a nuclear power station more efficient, because it is possible to avoid those efficiency limits caused by traditional pressure vessel structures. On the other hand as a safety risk for nuclear power stations is considered among other things also a collision danger of big air planes. Due to the above there has been a tendency to build stronger protective covers than before. There has been suggested also placement of such stations into cave spaces to be excavated into the bedrock, but until now such kind of arrangements are not known to have been carried out. One reason for the above may be the cumbersome transportation of pressure vessels into sites with a suitable bedrock as well as demanding lifting and transportation measures in difficult terrain environments. The pressure vessel according to the invention may instead be placed in a space being excavated inside bedrock, which brings about significant structural engineering savings when compared to present power stations and construction manners.

Advantageous embodiments of the pressure vessel of a pressurized-water reactor of a nuclear power station according to the invention have been presented in the independent claims related to the same.

The invention relates also to use of a multiwalled pressure vessel as a pressure vessel of a pressurized-water reactor of a nuclear power station, which has been defined by an independent claim of its own.

Use of a multiwalled pressure vessel brings about, as described above, remarkable advantages first of all for the part of manufacturing techniques and on the other hand also significant cost savings in terms of installation techniques thanks to the fact that the installation of the pressure vessel is made possible on site without massive transportation or lifting machinery.

In the following description the invention is being depicted in greater detail with reference to the attached drawings, whereby

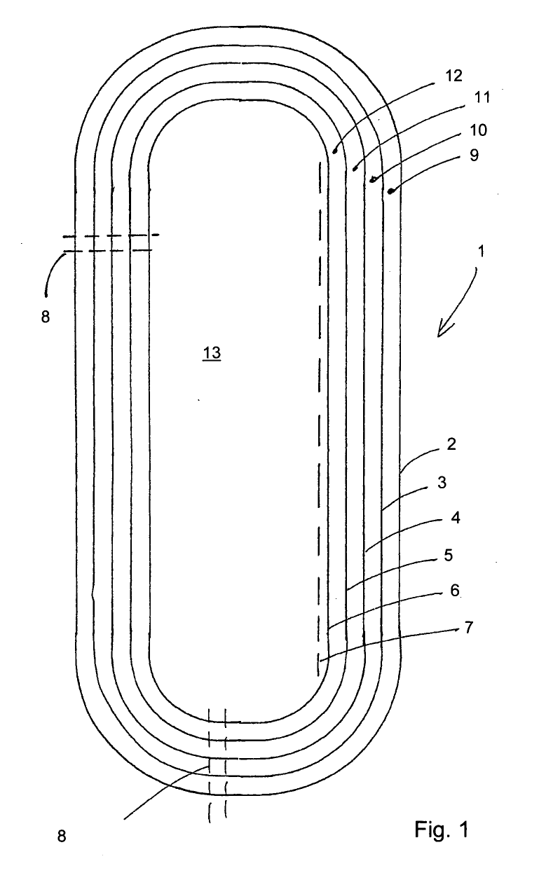

in FIG. 1 is shown a simplified diagram of some general principles of the invention,

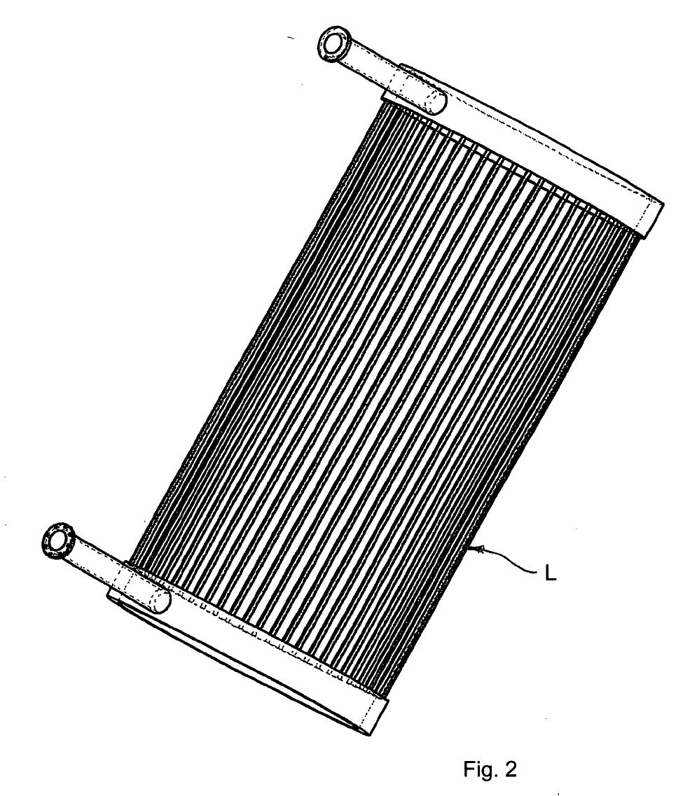

in FIG. 2 is shown as perspective view an internal heat exchanger to be exploited in a pressure vessel according to the invention,

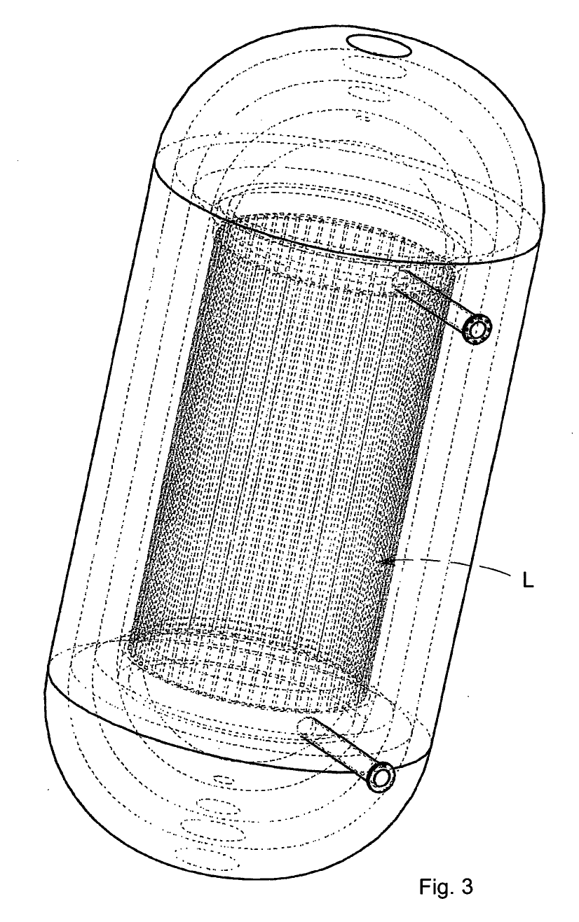

in FIG. 3 is shown a pressure vessel structure, as shown in FIG. 1, that is equipped with a heat exchanger, as shown in FIG. 2, and

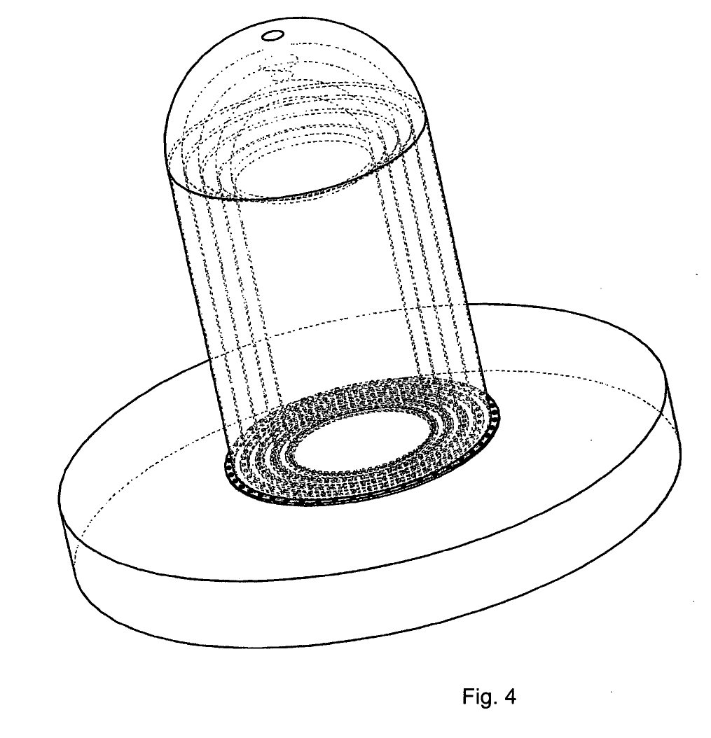

in FIG. 4 is shown an alternative pressure vessel structure with respect to FIGS. 1 and 3.

The invention relates first of all to a method for manufacturing a pressure vessel of a pressurized-water reactor of a nuclear power station, which pressure vessel comprises a pressure resistant casing and, which is being used filled with a medium in high pressure in order to utilize heat, being generated as a result of nuclear reaction taking place in an internal space 13 of the pressure vessel, by means of a heat exchange arrangement or like, being in connection with the pressure vessel. A casing of a pressure vessel 1 of a pressurized-water reactor, is being manufactured from two or more shell structures 5, 6 existing one within the other, whereby an essentially lower pressure than the pressure, existing in an internal space 13 of the pressure vessel, is being arranged in an intermediate space 12 between the shell structures.

The invention relates oh the other hand to a pressure vessel of a pressurized-water reactor of a nuclear power station, which comprises a pressure resistant casing and, which is meant to be used filled with a medium in high pressure in order to utilize heat, being generated as a result of a nuclear reaction taking place in an internal space 13 of the pressure vessel, by means of a heat exchange arrangement or like, being in connection with the pressure vessel. A casing of a pressure vessel 1 of a pressurized-water reactor consists of two or more shell structures 5, 6, existing, one within the other, whereby the pressure in an intermediate spaces 12 existing between the same, is lower than the pressure, existing, in an internal space 13 of the pressure vessel.

As an advantageous embodiment of the invention, the casing of the pressure vessel has at least three shell structures 4, 5, 6 one on top of the other, whereby the pressure in an intermediate space 11 of at least two outer shells 4, 5 is lower than the pressure in an intermediate space 12 of two inner shells 5, 6.

Furthermore as an advantageous embodiment, as shown in the enclosed FIG. 1, there exists several shell structures 2, 3, 4, 5, 6 forming said casing and existing one on top of the other, whereby the pressures of the intermediate spaces 12, 11, 10, 9 between the above decrease step by step when going outwards from the internal space 13.

Furthermore as an advantageous embodiment, the pressure vessel comprises a separate protecting plate or shell 7, at the opposite sides of which there exists essentially the same pressure and which is meant to protect the innermost shell structure 6 of the pressure vessel.

In practice the pressure in the intermediate spaces of the shell structures of a metal structured casing has been, achieved by gas or liquid pressure. The medium, being used in this context, in liquid or in gaseous form, may act simultaneously also as a part of the cooling system. On the other hand the cooling may be made more efficient or it can be carried out on totally new principles by exploiting the invention.

Furthermore, when utilized advantageously, one or several intermediate spaces 9, 10, 11, 12 of the shell structures 2, 3, 4, 5, 6 comprise a measurement device arrangement in order to determine/monitor pressure, temperature and/or a like physical, quantity. In this way it is easy to monitor and adjust functioning of separate parts of the pressure vessel. Already during a construction phase an adequate amount of measuring devices may be easily placed in the structure in order to monitor temperature, pressure and other physical quantities. On grounds of these, it is possible to make the necessary adjustment measures.

Furthermore as an advantageous embodiment in practice, the pressure vessel is manufactured from prefabricated and/or replaceable shell structures.

Furthermore in terms of flow techniques, the invention enables as an advantageous embodiment carrying out a heat recovery process of a nuclear reaction by circulating a medium, existing in one or several intermediate spaces 9, 10, 11, 12 belonging to its casing e.g. traditionally via an external heat exchange arrangement or like. Furthermore due to temperature and pressure, it is thus possible to exploit the invention in a way that e.g. the first intermediate shell space from inside would produce steam or at least hot liquid, which would be exploited as a heat exchange medium as is the case nowadays. On the other hand, thanks to the invention it is also possible to exploit also a heat exchanger L as shown e.g. in FIG. 2 in connection with a pressure vessel 1, as shown in FIG. 1, e.g. on the principle shown in FIG. 3. This kind of embodiment enables an essentially closed reactor space 13 of a pressure vessel, the medium of which needs not to be circulated at all through an external heat exchanger.

The invention relates also to use of a pressure vessel, a pressure resistant casing of which is formed of two or more shell structures 5, 6, existing one within the other, and whereby the pressure existing in an intermediate space 12, thereof, is lower than the pressure in an internal space 13 of the pressure vessel, as a pressure vessel of a pressurized-water reactor of a nuclear powerstation, which is meant to be used filled with medium in high pressure in order to utilize heat, being generated as a result of a nuclear reaction taking place in the internal space 13 of the pressure vessel, by means of a heat exchange arrangement or like, being in connection with the pressure vessel.

The simple basic idea of the invention is that a single shell structure of e.g. a casing made of metal of a pressure vessel 1 needs not to sustain as a single structural part the whole pressure, which exists in the internal space 13 of the pressure vessel, but instead the pressure can be shared to several shell structures 2-6 of the pressure vessel 1. Thus, the pressure in the intermediate space 12 is lower than the pressure in the internal space 13, but higher than the pressure in the intermediate space 11 and so on. One alternative particularly worth noticing is e.g. such that the pressure in the intermediate space 12 is greater than the pressure in the internal space 13, but the pressure in the intermediate space 11 is smaller than the pressure in the intermediate space 12, pressure in the intermediate space 10 lower than the pressure in the intermediate space 11 and the pressure in the intermediate space 9 smaller than the pressure in the intermediate space 10.

When being shared in the manner described above, the pressure sustained by any of the shell structures 2-6 will not be even close to a level of a pressure of such a structure, in which one single shell is made, which has to sustain the whole pressure of internal space 13 all by itself. In this way partly lighter structures will be achieved, that are easier to manufacture/machine when compared to single shell structures.

Furthermore, when exploiting the kind of pressure level arrangement e.g. as described above, it is possible to make sure particularly e.g. in a nuclear power station application such functioning that, in case the innermost shell structure 6 gets damaged, the radioactive material under pressure in the internal space 13 will not get discharged outwards, but instead the pressure of intermediate space gets discharged inwards, in which case monitoring of the decrease of pressure as has been described above, enables shutting down of the system or some other needed adjustment without the possible risks of the highly radioactive medium leaking outwards.

In the attached drawing there has been shown two separate things with broken lines. First of all the reference number 7 means a suitable plate like part, the intention of which is to act as a surface receiving radiation and simultaneously to protect the first shell 6 existing behind the same. As a matter of fact part 7, being mentioned above as plate like, may be as such also a shell, at the opposite sides of which there does not exist any pressure difference. So the protecting plate or shell 7 is of lesser importance by its characteristics than the shells that are meant to sustain pressure, such as e.g. shell layer 6. The meaning of shell 7 is thus to sustain expressly well the bombardment of the fine particles being generated by the nuclear reaction, and to protect those actual pressure shells against the said bombardment.

Other markings with broken. lines have been shown schematically also with reference number 8 and they mean inlets of control rods needed for nuclear reaction or other passage ways for steam or the like from one side to the other. It is clear that the amount of control rods in practice is naturally clearly higher than what has been shown in the drawing.

In FIG. 4 there has been shown furthermore an advantageous alternative with respect to the pressure vessel construction shown in FIGS. 1 and 3, in which the casing of the pressure vessel consists of casing parts existing one within the other and that are being attached by flange joints to a stationary base e.g. made of reinforced concrete.

The solution according to the invention has a large number of advantages, which have not been possible to achieve by prior techniques and striving for which has demanded very high economical sacrifices.

The meaning of the invention is based on the fact that the shell structures of the pressure vessel according to the invention are not such massive products as is the case with the single shell system, being exploited today. Thanks to this invention, a manufacturing technique is being enabled also in exploitation of nuclear power technique, which is quite a lot like usual machine workshop technique. The shell structures 2-6 (or more if needed), may be put together on site from parts being prefabricated. Because in this kind of environment there are already being used inspection devices, thanks to which safety inspections can be performed also on site, each and every structural part may also be checked in order to find out that it meets the desired criteria. The materials, to be used may naturally be checked as such already in the factory where they are manufactured. This is the way to operate e. g. for the part of metal plates.

Because the size/weight of the pressure vessel of the pressurized-water reactor is not any more a hinder, thanks to the invention it is possible to build nuclear power plant units e.g. with higher efficiency. In construction it is possible to exploit also materials deviating from each other in different shell structures, if needed.

The structures enabled by the invention can on the other hand be repaired, changed or complemented also afterwards, whereby the invention brings about significantly more flexibility to structures than the prior solutions. The invention enables also such kind of actions that e.g. certain parts of the shell structures and the like may be produced in stores as spare parts, just in case they will be needed afterwards.

In constructing a pressure vessel according to the invention there is thus not anymore a need for special transportations of materials, because the materials as well as their sizes correspond to materials, being already used usually in other connections. On the other hand, the parts of the pressure vessel according to the invention may be, when needed, prefabricated elsewhere than at its final station, so that they can be transported to its operating site only afterwards.

What has been described above, concerns also the prefabrication of e.g. inlets or the like, whereby lead-through pieces may be made, when needed, outside the actual construction site, to be attached to the stationary structures only after being transported to the site.

Choosing of the materials to be used in the pressure vessel according to the invention, as well as dimensioning of the structures require ordinary technique only, whereby in choosing of materials, necessary factors regarding safety technique, needed in a destination, are being used. The dimensioning, manufacturing and other peripheral measures of the pressure vessel of a nuclear reactor are very simple tasks as a whole when compared to the cast technique, required by present technique. On grounds of the above, it is clear that thanks to the invention e.g. a pressure vessel of a nuclear reactor may be made easily decisively more safe than at present. As an example may be mentioned also the fact that, particularly due to the special meaning of the innermost shell structure 6, those special demands should be kept in mind, when choosing its material, that are caused to the operating life time of the material by the nuclear reactor. On the other hand, as has been stated already before, it is also possible to use a separate screen wall or shell in order to sustain the mentioned stresses.

In the foregoing there has not been interfered in greater detail the shell structures as such. So, each shell structure may first of all be a stationary entirety and manufactured from any pressure resistant material, such as plastic. A metal structured pressure vessel may be e.g. welded together as a single entirety, but shell structures, being put together from separate parts by other ways than weld joints, are not out of the question and such may even be recommendable particularly with a view to service and maintenance measures. One possible way is to make each shell e.g. of two or three parts; e.g. an essentially cylindrical centre part from one piece and the cover or covers from different parts. In this case the parts may be coupled with each other e.g. by bolted flange joints. This kind of embodiments have not, however, been shown in the enclosed drawing.

The philosophy of several shells is thus advantageous due to the fact that the pressure resistance of each

shell structure may be clearly lower than the same in an implementation with one single shell/vessel. However, it is clear that the strength of the shell structures must be dimensioned so that breakage of one single shell structure and directing of the pressure, being e.g. double,d to the next shell structure, does not cause any problems.

The auxiliary variations enabled by the invention are very manyfold particularly when compared to the present technique. So, the attached principal diagram is not meant to be limiting in any way, but instead the invention may be modified in many ways within the basic idea of the invention and within the scope of protection of the attached claims. So the principles of the invention may be exploited also in nuclear power plants based on so called boiling water system, as well as in other reactor alternatives, too.

1. Method for manufacturing a pressure vessel of a pressurized-water reactor of a nuclear power station, which pressure vessel comprises a pressure resistant casing and configured to be fitted with a medium in high pressure in order to utilize heat generated as a result of nuclear reaction taking place in an internal space of the pressure vessel, by means of a heat exchange arrangement connected to the pressure vessel, comprising providing a casing of a pressure vessel of the pressurized-water reactor manufactured from two or more shell structures existing one within the other, whereby an essentially tower pressure than the pressure, existing in an internal space of the pressure vessel occurs in an intermediate space between the shell structures, wherein the casing of the pressure vessel is manufactured essentially on site.

2. Pressure vessel of a pressurized-water reactor of a nuclear power station, which comprises a pressure resistant casing and is configured to be filled with a medium at high pressure in order to utilize heat, generated as a result of a nuclear reaction taking place in an internal space of said pressure vessel, by means of a heat exchange arrangement connected with the pressure vessel, wherein a casing of the pressure vessel of the pressurized-water reactor comprises two or more shell structures, existing one within the other, whereby a pressure in an intermediate space existing therebetween is lower than a pressure in an internal space of said pressure.

3. Pressure vessel according to claim 2, wherein a heat recovery process of the nuclear reaction is carried out with an internal heat exchanger in one or several intermediate spaces of said casing.

4. Pressure vessel according to claim 2, further comprising, in one or several intermediate spaces of the shell structures, a measurement device arrangement in order to determine/monitor pressure, temperature and/or a like physical quantity.

5. Pressure vessel according to claim 2, further comprising a separate protecting plate or shell, at the opposite sides of which there exists essentially the same pressure and which is configured to protect an innermost shell structure of said pressure vessel.

6. Pressure vessel according to claim 2, in a case of at least three cell structures, a pressure in a first intermediate space, counted from inside out, is higher than a pressure in the internal space of the vessel.

7. (canceled)

8. Method of claim 1, wherein the casing is manufactured with prefabricated and/or replaceable shell structures.

9. Pressure vessel of claim 2, wherein said casing of said pressure vessel is constructed of prefabricated and/or replaceable shell structures.
